(19) United States
(12) Patent Application Publication
(10) Pub. No.: US 2008/0090028 A1
(43) Pub. Date: Apr. 17, 2008

(54) Liquid Crystal Display

(76) Inventors: Kuang-Rong Lee, Ping Chen (TW); Min-Wei Cheng, Ping Chen (TW)

Correspondence Address: Alan D. Kamrath;Kamrath & Associates., P. A., Suite 245, 4825 Olson Memorial Highway, Golden Valley, MN, 55422, US

(21) Appl. No.: 11/849,032

(22) Filed: Aug. 31, 2007

(30) Foreign Application Priority Data
Oct. 16, 2006 (TW) 095138070

(51) Int. Cl. G02F 1/361

(52) U.S. Cl. 428/1.33

(57) ABSTRACT

A liquid crystal display includes: a backlight module, a LCD panel, a first polarizer, and a second polarizer. The LCD panel is disposed over the emitting surface of the backlight module, the first polarizer is disposed between the backlight module and the LCD panel, and the second polarizer, relative to the first polarizer, is disposed on the other side of the LCD panel. The first polarizer includes a first polarizing layer, a first optical film, and a second optical film. The first optical film is disposed on the one side of the first polarizing layer, and the second optical film, relative to the first optical film, is disposed on the other side of the first polarizing layer. The second optical film is a Polymethyl Methacrylate optical film, and the second optical film is closer to the LCD panel than the first optical film does.

### BACKGROUND OF THE INVENTION

1. Field of the Invention

The present invention relates to a liquid crystal display (LCD) and particularly to a liquid crystal display that has an optical film made from polymethyl methacrylate.

2. Description of the Prior Art

Refer to FIG. 1 for the structure of a general LCD now on the market. The LCD 100 includes a backlight module 110, polarizers 120, a LCD panel 130 and a color filter 140. The backlight module 110 aims to provide a light source. The polarizers 120 are located above and beneath the LCD panel 130.

Refer to FIG. 2 for the structure of a conventional polarizer. The polarizer 120 mainly includes two TAC (Triacetyl cellulose) films 124 and a PVA (Polyvinyl alcohol) film 122. The PVA film 122 is sandwiched between the two TAC films 124. The PVA film 122 aims to provide polarization, while the TAC films 124 aim to protect and support the PVA film 122.

Traditionally, the TAC films 124 have a smaller Re retardation value (called Re value in short hereinafter), but have a higher Rth retardation value (called Rth value in short hereinafter). The higher Rth value causes a lower optical compensation on the LCD (especially IPS LCD). For instance, a lower contrast ratio or color shift is generated at a diagonal visual angle. Hence to reduce the Rth value of the TAC films 124 is an important issue in the industry.

Prior patent references such as JP1998330538, JP1999246704, JP2001206981 and JP2006010863 disclose processing methods that add a special solvent such as bromopropane, glyceride or the like to the TAC film, or employ a process using carboxyl solvent to reduce the Rth value. However the manufacturing processes of those methods are complex, and the Rth value of the TAC film cannot be reduced close to zero.

There are other patent references such as JP1999005851, JP2001129927, JP2001163995, and JP2005097621 that disclose techniques to modify the chemical structure of the TAC film to get a lower Rth value. But they also involve complex processes and cannot reduce the Rth value close to zero.

In recent years, Koike et al (Science, 301, 812, 2003) propose inorganic crystal zero-birefringence polymers. However, the polymer chain of the polymer film tends to extend on the in-plane plane. To reduce the Rth value of the polymer film made from the polymers is difficult.

Nakayama et al (IDW 05 FMC 11-2) propose a low phase delay TAC film, also called FUJI FILM Z-TAC. The TAC film is made by including special additives and through a special manufacturing technique. It has almost zero Re and Rth values. But including the additives increases material cost. The thermal stability of the TAC film also decreases.

The conventional TAC films, aside from a higher Rth value, also have other problems such as greater water absorption and moisture permeability. When used in a high temperature and high humidity condition the TAC films tend to deform or generate stress due to the external environment. This affects the optical characteristics and even makes the films not usable.

Because of the aforesaid problems occurred to the conventional TAC films, the LCD display using the TAC films suffers bad quality. The present invention aims to provide a LCD that includes at least one polarizer which has an optical film made from polymethyl methacrylate. Compared with the conventional TAC films, the optical film thus formed has a lower Rth value and desirable water absorption and moisture permeability characteristics.

### SUMMARY OF THE INVENTION

The object of the present invention is to provide a LCD that includes at least one polarizer which has an optical film made from polymethyl methacrylate to enable the LCD to have improved display quality.

To achieve the foregoing and other objects, the LCD according to the invention includes a backlight module, a LCD panel, a first polarizer and a second polarizer. The LCD panel is located above the emitting surface of the backlight module. The first polarizer is located between the backlight module and the LCD panel. The second polarizer is located on other side of the LCD panel relative to the first polarizer. The first polarizer includes a first polarizing layer, a first optical film and a second optical film. The first optical film is located on one side of the first polarizing layer. The second optical film is located on other side of the first polarizing layer relative to the first optical film. The second optical film is made from polymethyl methacrylate and closer to the LCD panel than the first optical film does.

On the LCD mentioned above, the optical film made from polymethyl methacrylate includes a material selected from either of PMMA (Polymethyl methacrylate), PMMA with a replaced functional group and PMMA mixing groups, and a solvent. The material of PMMA, PMMA with a replaced functional group or PMMA mixing groups is blended evenly at a desired ratio in the solvent according to the required characteristics of the PMMA optical film.

In one aspect the optical film of polymethyl methacrylate, the amount of the PMMA, PMMA with a replaced functional group or PMMA mixing groups is blended at a ratio of 20% to 40% by weight in the solvent.

In another aspect the functional group being replaced in the PMMA with a replaced functional group is methyl. The methyl may be selectively replaced by other functional groups such as ethyl, propyl, isopropyl, n-butyl, isobutyl, neo-butyl, n-hexyl, isohexyl, cyclohexyl or the like.

In yet another aspect the solvent in the optical film of polymethyl methacrylate is selected from either of methyl benzene, acetone, methyl acetate, aromatics, cycloalkanes, ethers, esters and ketones. The aromatics may be selected from either of methyl benzene, O-Xylene, M-Xylene and P-Xylene. The cycloalkanes include cyclohexane. The ethers is selected from either of Diethyl ether and Tetrahydrofuran. The esters is selected from either of methyl acetate and ethyl acetate. The ketones is selected from either of acetone, methylethylketone and 1-methylpyrrolidone.

In yet another aspect, the optical film of polymethyl methacrylate further includes multiple particles formed by either of PMMA, PMMA with a replaced functional group or PMMA mixing groups covered by an elastic rubber material.

In yet another aspect, in the optical film of polymethyl methacrylate the elastic rubber material is selected from the family consisting of butyl acrylate, polymethyl methacrylate and styrene. The adding amount of the particles is 2.5% to 50% by weight.

In yet another aspect, the optical film of polymethyl methacrylate further includes silica at the amount of 0.5% to 15% by weight.

On the LCD mentioned above, the polarizer is mainly made from polyvinyl alcohol.

The first optical film mainly is made from Triacetyl-cellulose, Polycarbonate or Cyclic olefin polymer.

The first optical film also may be formed by the same composition as the optical film of polymethyl methacrylate does.

The second polarizer includes a second polarizing layer, a third optical film and a fourth optical film. The third optical film is located on one side of the second polarizing layer and made mainly from Triacetyl-cellulose, Polycarbonate or Cyclic olefin polymer. The fourth optical film is located on other side of the second polarizing layer relative to the third optical film. The fourth optical film also is mainly made from Triacetyl-cellulose, Polycarbonate or Cyclic olefin polymer.

Moreover, the fourth optical film also may be formed by the same composition as the optical film of polymethyl methacrylate does.

The third optical film also may be formed by the same composition as the optical film of polymethyl methacrylate does.

As the LCD of the invention has the optical film of polymethyl methacrylate on the polarizer that has a lower Rh value than the TAC film and more desirable water absorption and moisture permeability characteristics, an improved display quality can be achieved.

On the LCD of the invention mentioned above, the LCD panel adopts In-Plane Switching (generally called IPS).

The foregoing, as well as additional objects, features and advantages of the invention will be more readily apparent from the following detailed description, which proceeds with reference to the accompanying drawings. The embodiments discussed hereinafter serve only illustrative purpose and are not the limitation of the invention. The scope of the invention is defined by the Claims listed below.

### BRIEF DESCRIPTION OF THE DRAWINGS

FIG. 1 is a schematic view of the structure of a conventional LCD.

FIG. 2 is a schematic view of the structure of a conventional polarizer.

FIG. 3 is a schematic view of the structure of an embodiment of the LCD of the invention.

FIG. 4A is a schematic view of the structure of the first polarizer according to FIG. 3.

FIG. 4B is a schematic view of the structure of the second polarizer according to FIG. 3.

FIG. 5A is a color dispersion diagram of a conventional LCD showing color, luminosity and darkness conditions from left to right.

FIG. 5B is a color dispersion diagram of an embodiment of the LCD of the invention showing color, luminosity and darkness conditions from left to right.

FIG. 6 is a schematic view of the structure of the second polarizer of another embodiment of the invention

FIG. 7A is a color dispersion diagram of a conventional LCD showing color, luminosity and darkness conditions from left to right.

FIG. 7B is a color dispersion diagram of another embodiment of the LCD of the invention showing color, luminosity and darkness conditions from left to right.

### DESCRIPTION OF THE PREFERRED EMBODIMENTS

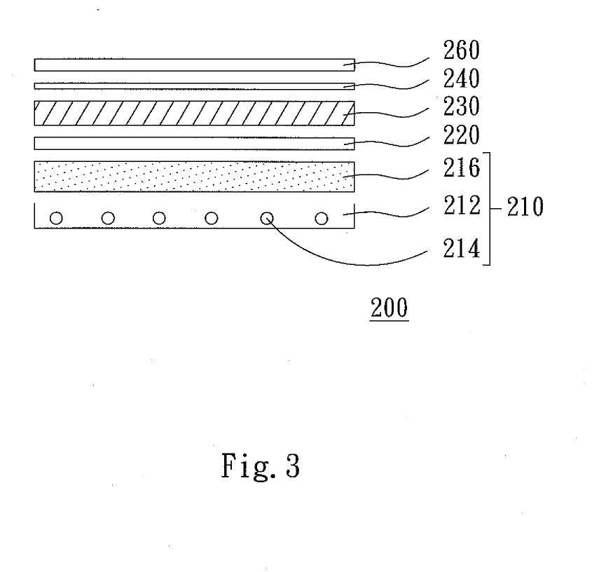

Refer to FIG. 3 for the structure of an embodiment of the LCD of the invention. The LCD 200 includes a backlight module 210, a first polarizer 220, a LCD panel 230, a color filer 240 and a second polarizer 260. The backlight module 210 provides a light source. The first polarizer 220 is located beneath the LCD panel 230. Light passing through the first polarizer 220 is polarized. The polarized light passes through liquid crystal molecules of the LCD panel 230. As the arrangement of the liquid crystal molecules is affected by the voltage of the electrodes (not shown in the drawings) of the LCD panel 230, the polarized angle of the polarized light can be altered by the liquid crystal molecules. The light of different polarized angles passes through the color filter 240 and second polarizer 260 to generate colored lights of different colors and luminosities. Finally the colored lights are combined to form various images visible to people's eyes.

The backlight module 210 includes a reflection mask 212, a light source 214 and a light guide 216. The light emitted from the light source 214 (such as cold cathode fluorescent lamp) is reflected by the reflection mask 212 and directed by the light guide 216 to be projected outwards to the LCD panel 230. In this embodiment the backlight module 210 is a direct type backlight module. It also may be sideward incident type or other types.

The LCD panel 230 adopts In-Plane Switching (generally called IPS) or other desired types such as multi-vertical alignment (generally called MVA) type.

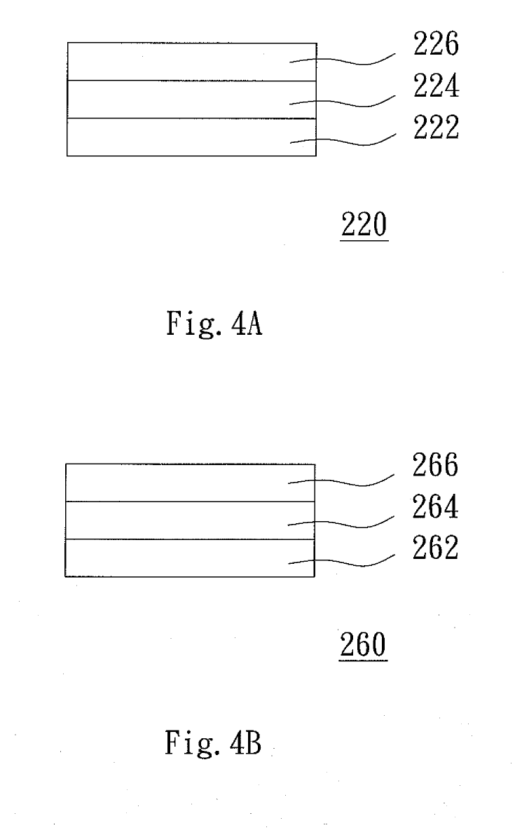

Referring to FIGS. 3, 4A and 4B, the first polarizer 220 includes a first optical film 222, a first polarizing layer 224 and a second optical film 226. When the first polarizer 220 is installed on the LCD 220, the second optical film 226 is located between the LCD panel 230 and the first polarizing layer 224. The first optical film 222 is located below the first polarizing layer 224. The first optical film 222 and the second optical film 226 both aim to protect and support the first polarizing layer 224. The second optical film 226 is made from polymethyl methacrylate. In this embodiment the first polarizing layer 224 is made from a polarized material and has a specific polarized direction to allow the light to pass through. The first polarizing layer 224 mainly is made from polyvinyl alcohol (PVA).

Referring to FIGS. 3 and 4B, the second polarizer 260 includes a third optical film 262, a fourth optical film 266 and a second polarizing layer 264. The third optical film 262 is located on one side of the second polarizing layer 264. The fourth optical film 266 is located on other side of the second polarizing layer 264. The third optical film 262 and the fourth optical film 266 both aim to protect and support the second polarizing layer 264. In this embodiment the third optical film 262 and the fourth optical film 266 mainly are made from Triacetyl cellulose (TAC). The second polarizing layer 264 is made from polyvinyl alcohol (PVA).

The optical film made from polymethyl methacrylate previously discussed includes a material selected from either of PMMA, PMMA with a replaced functional group and PMMA mixing groups, and a solvent. The material of PMMA, PMMA with a replaced functional group or PMMA mixing groups is blended evenly at a desired ratio in the solvent according to required characteristics of the optical film of polymethyl methacrylate, preferably at the amount between 20% and 40% by weight.

The functional group of PMMA to be replaced set forth above is methyl. The methyl may be selectively replaced by other functional groups such as ethyl, propyl, isopropyl, n-butyl, isobutyl, neo-butyl, n-hexyl, isohexyl, cyclohexyl or the like. The PMMA mixing groups include at least a kind of polymer, small molecular, plasticizer, UV absorbent, antidegradant or nano scale particles. The solvent includes at least aromatics, cycloalkanes, ethers, esters, ketones or mixing materials thereof. The aromatics is selected from either of methyl benzene, O-Xylene, M-Xylene and P-Xylene. The cycloalkanes include cyclohexane. The ethers is selected from either of Diethyl ether and Tetrahydrofuran (THF). The esters is selected from either of methyl acetate and ethyl acetate. The ketone group is selected from either of acetone, methylethylketone (MEK) and 1-methylpyrrolidone (NMP). The solvents set forth above serve only as an embodiment and are not the limitation of the invention.

The nano scale particles have diameters smaller or equal to 100 nanometers, preferably smaller than 80 or 50 nanometers. Moreover, the optical film of polymethyl methacrylate may further include silica at the amount of 0.5% to 15% by weight.

The optical film of polymethyl methacrylate may further include multiple particles formed by either of PMMA, PMMA with a replaced functional group or PMMA mixing groups covered by an elastic rubber material. The elastic rubber material may be selected from the family consisting of butyl acrylate, polymethyl methacrylate and styrene. The elastic rubber articles are formed at a size smaller than 10 micrometers or even at nanometer scale. The adding amount of the particles is 2.5% to 50% by weight. By adding the elastic rubber particles the mechanical characteristics of the optical film can be improved, including enhancing the extensibility and the like.

The second optical film 226 has been tested with optical characteristics shown in Table 1 listed below:

TABLE 1

| | |
|---|---|
| Light transmission | 95.23% |
| Haze | 0.23% |
| Hueb | 0.29 |
| Re value | 0.2 nm |
| Rth value | 2.9 nm |

The light transmission of the second optical film 226 was measured through a Spectrophotometer (such as HITACHI U-4100 Spectrophotometer). During measuring process the second optical film 226 at a size of 4×4 cm² is disposed at a measuring position and scanned by a light of wavelength in the range of 380-700 nm. The light transmission of the second optical film 226 shown in Table 1 is obtained at the wavelength of 550 nm.

The Haze of the second optical film 226 is measured through a Haze meter (such as NDH 2000 Haze meter). During the measuring process a calibration testis done first, then the second optical film 226 at the size of 4×4 cm²is disposed at the measuring position to get the haze value.

The thickness of the second optical film 226 is measured through an optical thickness meter of model No. ETA-STC. During measuring process the second optical film 226 is positioned and the refraction index of the second optical film 226 is entered. Through optical reflection principle the thickness of the second optical film 226 can be obtained. The refraction index of the second optical film 226 can be measured through an ABBE Refractometer. For instance using a filter of wavelength 589 nm, the thickness of the second optical film 226 under the wavelength of 589 nm can be obtained.

Then the Re and Rh values of the second optical film 226 can be measured through an Optical birefringence analyzer such as model No. KOBRA-21ADH. The second optical film 226 of 4×4 cm² is placed on the measuring position; input the thickness and measuring angular range (−50^{˜50}^{) of the second optical film 226; the Optical birefringence analyzer measures the second optical film 226 at an interval of} 10 ^{in different angles; after the measurement is finished, enter the refraction index of the second optical film 226, and the Re and Rh values of the second optical film 226 can be obtained.}

The measurement facilities and processes previously discussed are only examples. To those skilled in the art other suitable measurement facilities may be selected and the measurement processes can be altered to measure various optical characteristics of the second optical film 226.

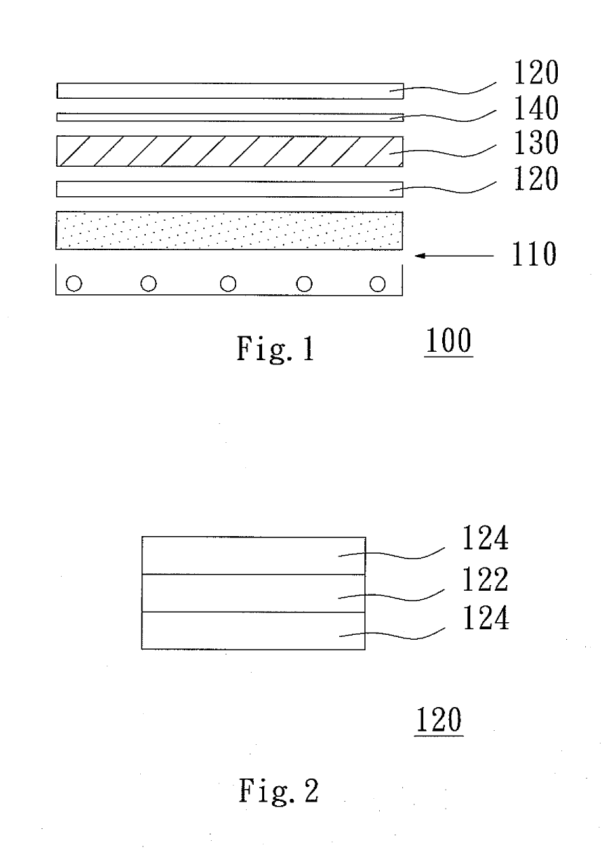

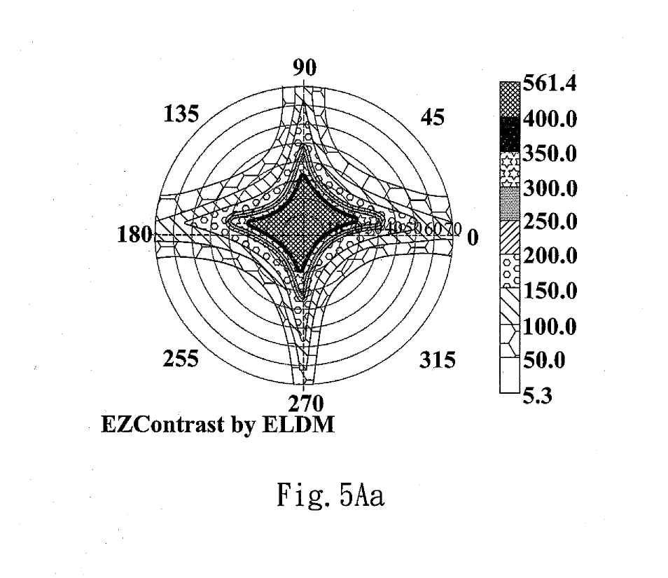

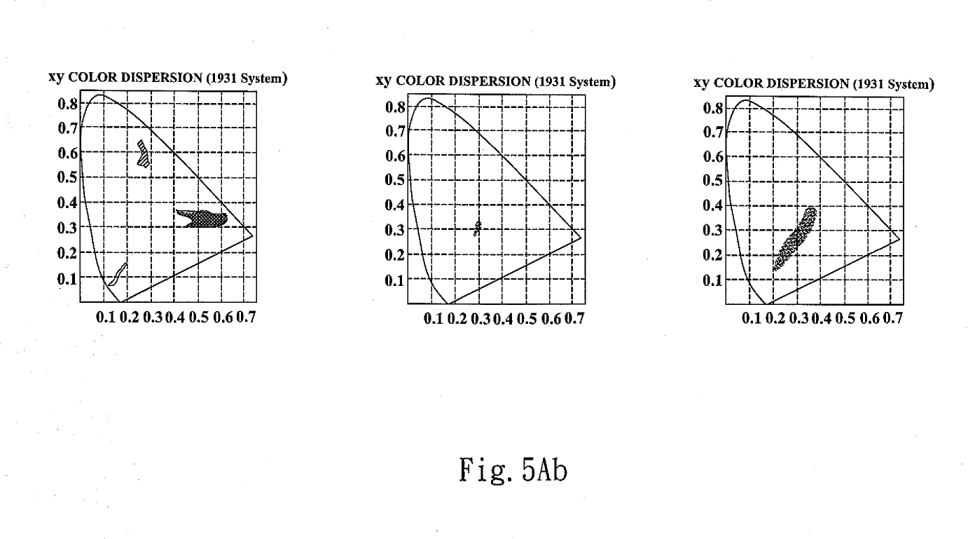

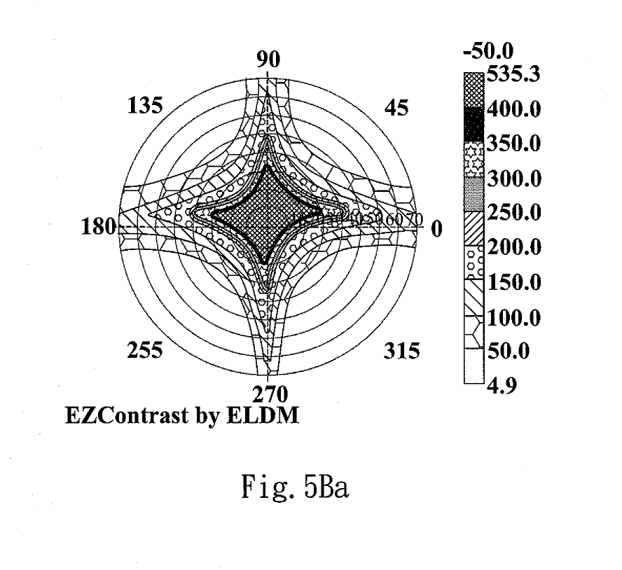

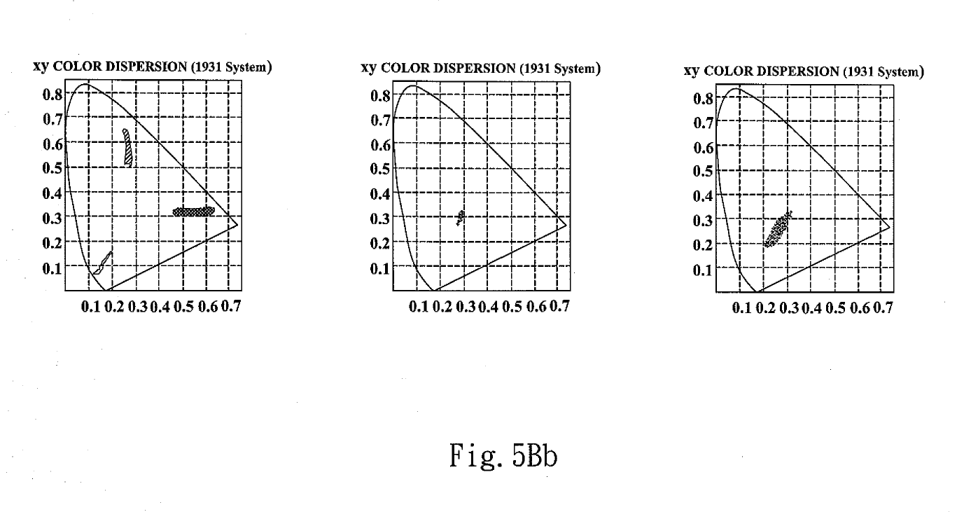

Compared the embodiment of the LCD of the invention with the conventional one (referring to FIG. 1), the embodiment of the LCD of the invention has an improved display effect. FIG. 5A shows a color dispersion diagram on color, luminosity and darkness conditions from left to right of the conventional LCD. FIG. 5B shows a color dispersion diagram on color, luminosity and darkness conditions from left to right of the embodiment of LCD of the invention. Comparison of the color dispersion diagrams of FIGS. 5A and 5B indicates that the optical characteristics of the embodiment of LCD of the invention are much better than the conventional one.

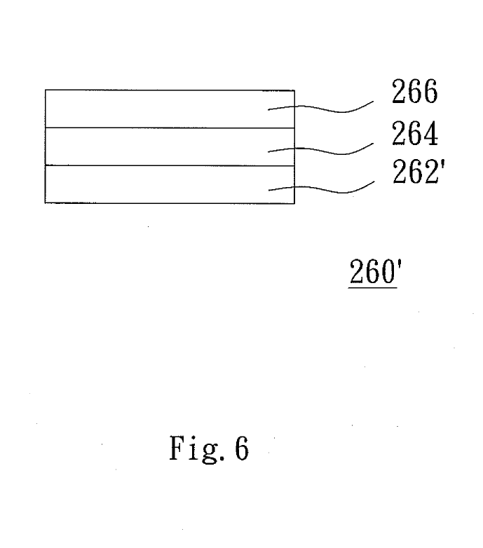

The third optical film 262 previously discussed mainly is made from Triacetyl-cellulose. But it also can be formed by the same composition as the second optical film 226 does. Refer to FIG. 6 for another embodiment of the structure of the second polarizer. The third optical film 262′ on the second polarizer 260′ is made by the same composition as the second optical film 226. When the second polarizer 260′ is installed on the LCD 200, the third optical film 262′ is located between the LCD panel 230 and the second polarizing layer 264.

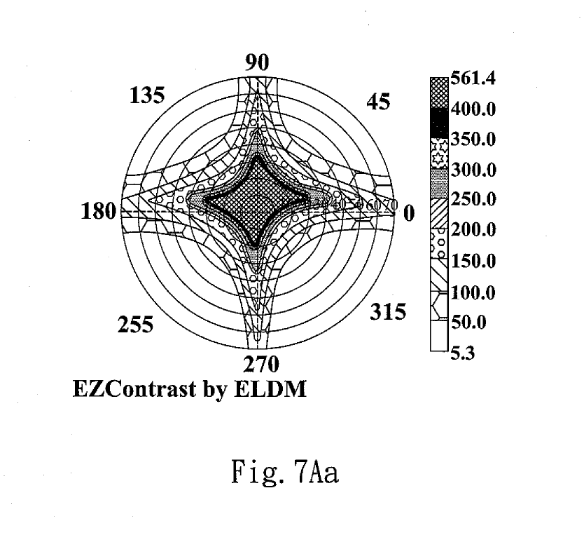

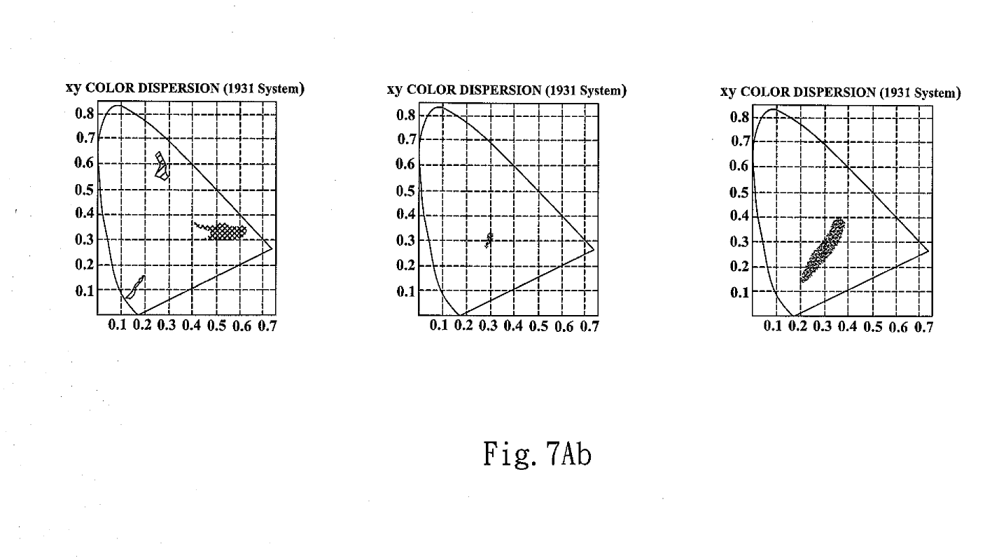

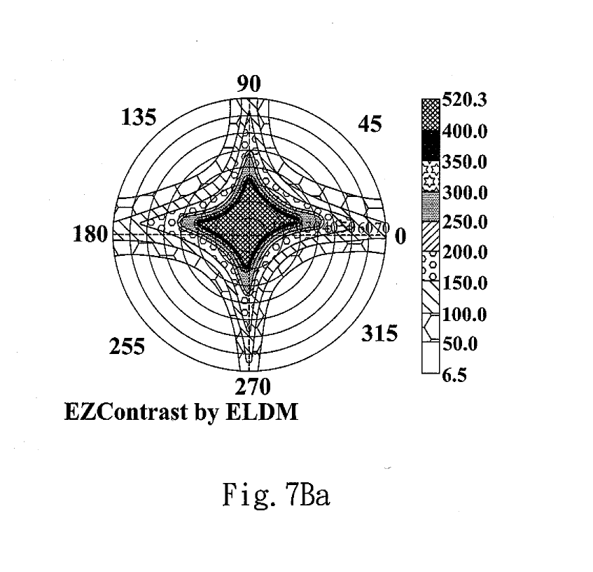

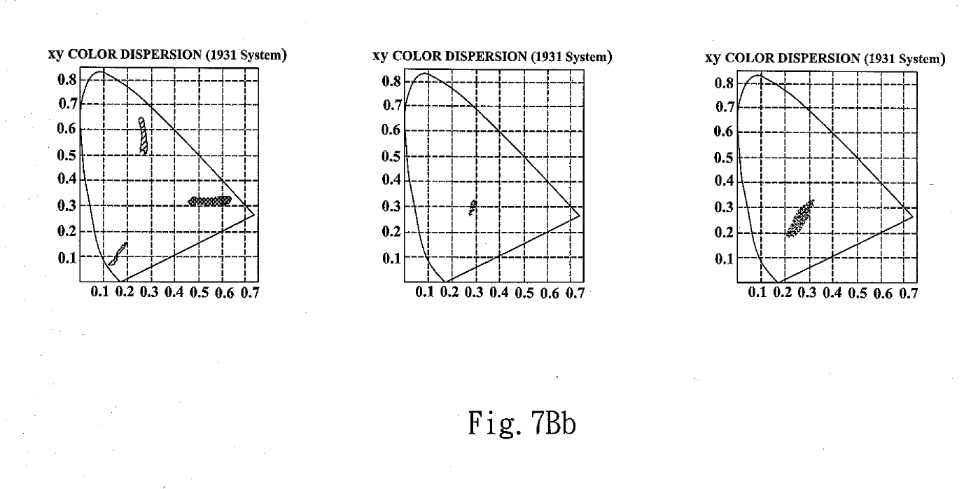

Compared another embodiment of LCD of the invention with the conventional one (referring to FIG. 1), the another embodiment of LCD of the invention has an improved display effect. FIG. 7A shows a color dispersion diagram on color, luminosity and darkness conditions from left to right of the conventional LCD. FIG. 7B shows a color dispersion diagram on color, luminosity and darkness conditions from left to right of the another embodiment of LCD of the invention. Comparison of the charts of FIGS. 5A and 5B indicates that the optical characteristics of the LCD of the another embodiment of the invention are much better than the conventional one.

The first polarizer 220 and second polarizer 260′ previously discussed have the optical film of polymethyl methacrylate disposed only on one side of the polarizing layers (namely the first polarizing layer 224 and the second polarizing layer 264), namely the second optical film 226 and the third optical film 262′. However, the first optical film 222 or the fourth optical film 266 may also be made by the same composition as the second optical film 226 and the third optical film 262′ do. In the embodiment and another embodiment set forth above, the first polarizing layer 224 and the second polarizing layer 262 are mainly made from polyvinyl alcohol. Of course, other types of polarizing material may also be used.

In addition, in the embodiments set forth above, Triacetyl-cellulose is used as the main material to make the optical films (such as the first optical film 222 or fourth optical film 266). It may be replaced by other suitable materials as polycarbonate or cyclic olefin polymer.

Moreover, as polymethyl methacrylate has a smaller water absorption capability and moisture permeability than Triacetyl-cellulose, the second optical film 226 and the third optical film 262′ have more desirable water absorption capability and moisture permeability than the conventional TAC film. Hence when the second optical film 226 and the third optical film 262′ are used in high temperature and humidity conditions, they are less likely to deform or generate stress due to external environments. Thus the optical characteristics are less likely to be affected.

Furthermore, as the second optical film 226 and third optical film 262′ are made from polymethyl methacrylate which is a polymer, they have improved mechanical characteristics such as greater toughness and the like.

In short, the LCD of the invention mainly includes one optical films made of polymethyl methacrylate. Its has improved display quality than the conventional LCDs. Moreover, the optical films of the invention have smaller water absorption characteristics and moisture permeability than TAC film, and enhanced toughness. Hence the optical films are less likely to deform or generate stress due to external environments, and optical characteristics also are less likely to be affected. The life span of the LCD of the invention also is longer than the conventional ones.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A liquid crystal display, comprising:
a backlight module;
a LCD panel located above an emitting surface of the backlight module;
a first polarizer located between the backlight module and the LCD panel; and
a second polarizer located on other side of the LCD panel relative to the first polarizer;
wherein the first polarizer includes:
a first polarizing layer;
a first optical film located on one side of the first polarizing layer; and
a second optical film located on other side of the first polarizing layer relative to the first optical film; the second optical film being made from polymethyl methacrylate and closer to the LCD panel than the first optical film does.

2. The liquid crystal display of claim 1, wherein the optical film of polymethyl methacrylate includes:
a material selected from the group consisting of PMMA, PMMA with a replaced functional group and PMMA mixing groups; and
a solvent;
wherein the material selected from the group consisting of PMMA, PMMA with a replaced functional group and PMMA mixing groups is evenly blended at a desired ratio in the solvent according to required characteristics of the optical film of polymethyl methacrylate.

3. The liquid crystal display of claim 2, wherein the amount of the material selected from the group consisting of PMMA, PMMA with a replaced functional group and PMMA mixing groups is blended in the solvent at a ratio between 20% and 40% by weight.

4. The liquid crystal display of claim 2, wherein the functional group being replaced in the PMMA with a replaced functional group is methyl which is selectively replaced by either of ethyl, propyl, isopropyl, n-butyl, isobutyl, neo-butyl, n-hexyl, isohexyl and cyclohexyl.

5. The liquid crystal display of claim 2, wherein the solvent is selected from either of methyl benzene, acetone, methyl acetate, aromatics, cycloalkanes, ethers, esters and ketones;
wherein the aromatic family is selected from either of methyl benzene, O-Xylene, M-Xylene and P-Xylene, the cycloalkanes include cyclohexane, the ethers is selected from either of Diethyl ether and Tetrahydrofuran, the esters is selected from either of methyl acetate and ethyl acetate, and the ketones is selected from either of acetone, methylethylketone (MEK) and 1-methylpyrrolidone (NMP).

6. The liquid crystal display of claim 2, wherein the optical film of polymethyl methacrylate further includes pluralities of particles formed by either of PMMA, PMMA with a replaced functional group or PMMA mixing groups covered by an elastic rubber material.

7. The liquid crystal display of claim 6, wherein the elastic rubber material is selected from the family consisting of butyl acrylate, polymethyl methacrylate and styrene, the included amount of the particles being 2.5% to 50% by weight.

8. The liquid crystal display of claim 2, wherein the optical film of polymethyl methacrylate further includes silica at an amount of 0.5% to 15% by weight.

9. The liquid crystal display of claim 1, wherein the polarizing layer is mainly made from polyvinyl alcohol.

10. The liquid crystal display of claim 1, wherein the first optical film mainly is made from Triacetyl-cellulose, Polycarbonate or Cyclic olefin polymer.

11. The liquid crystal display of claim 1, wherein the first optical film is made from polymethyl methacrylate.

12. The liquid crystal display of claim 1, wherein the second polarizer includes:
a second polarizing layer;
a third optical film located on one side of the second polarizing layer and made mainly from Triacetyl-cellulose, Polycarbonate or Cyclic olefin polymer; and
a fourth optical film located on other side of the second polarizing layer relative to the third optical film, and made mainly from Triacetyl-cellulose, Polycarbonate or Cyclic olefin polymer.

13. The liquid crystal display of claim 1, wherein the second polarizer includes:
a second polarizing layer;
a third optical film located on one side of the second polarizing layer; and
a fourth optical film located on other side of the second polarizing layer relative to the third optical film;
wherein the fourth optical film is made from polymethyl methacrylate, the fourth optical film being closer to the LCD panel than the third optical film does.

14. The liquid crystal display of claim 13, wherein the second polarizing layer is mainly made from polyvinyl alcohol.

15. The liquid crystal display of claim 13, wherein the third optical film is mainly made from Triacetyl-cellulose, Polycarbonate or Cyclic olefin polymer.

16. The liquid crystal display of claim 13, wherein the third optical film is made from polymethyl methacrylate.

17. The liquid crystal display of claim 1, wherein the LCD panel is an in-plane switching type.
